(19) United States
(12) Patent Application Publication
(10) Pub. No.: US 2010/0230208 A1
(43) Pub. Date: Sep. 16, 2010

(54) CONVERTIBLE MULTIPURPOSE LADDER STABILIZERS

(76) Inventors: Hongwei Hsiao, Morgantown, WV (US); Shengke Zeng, Morgantown, WV (US); James Hsiao, Morgantown, WV (US); Peter Simeonov, Morgantown, WV (US); Douglas Cantis, Morgantown, WV (US)

Correspondence Address: GIFFORD,KRASS,SPRINKLE,ANDERSON&CITKOWSI, PC, 2701 W. BIG BEAVER ROAD, P.O. BOX 7021, SUITE 330, TROY, MI, 48007-7021, US

(21) Appl. No.: 12/402,077

(22) Filed: Mar. 11, 2009

(51) Int. Cl. E06C 7/18

(52) U.S. Cl. 182/106; 182/129

(57) ABSTRACT

A multipurpose ladder accessory assembly for a ladder having a top rung, a penultimate rung and a multiple of lower rungs each extending between a first elongated ladder rail and a second elongated ladder rail defining ladder rails, each ladder rail having an upper end and a lower end, said accessory assembly comprising a first and second pair of ladder accessory arms each defining a first arm connected to the first ladder rail between the upper end of the first ladder rail and the penultimate rung, and a second arm connected to the second ladder rail between the upper end of the second ladder rail and the penultimate rung, such that each of the first arms and the second arms of the first and the second pair of ladder accessory arms are independently moveable from a folded position along the ladder rails to an extended position from the ladder rails.

### GOVERNMENT INTEREST

The invention described herein may be manufactured, used, and licensed by or for the United States Government.

### FIELD OF THE INVENTION

The present invention relates to an attachment for a ladder to improve and extend the usefulness of the ladder, more particularly to a multipurpose ladder accessory assembly.

### BACKGROUND OF THE INVENTION

Ladder accessories are useful in stabilizing a ladder so as to prevent slipping or tipping incidents which can result in injury to the user. Further, ladder accessories can be used to space the ladder apart from the vertical support surface upon which it rests so as to provide the user with a greater access to a work area on the vertical support surface. As ladders are a versatile tool there are numerous ladder accessories which can be attached to a ladder to perform a specific requirement. This results in disparate accessories which have to be stored, carried to the worksite, and attached to the ladder as each requirement arises. Further, once a ladder accessory has been attached to a ladder and a new ladder accessory requirement arises the user must remove the current ladder accessory, retrieve the new ladder accessory from storage and attach the new accessory to the ladder.

Thus, there exists a need for a multipurpose ladder accessory assembly which can compactly store several ladder accessories on the ladder, and which can quickly deploy the accessories as a requirement arises.

### SUMMARY OF THE INVENTION

The present invention provides a multipurpose ladder accessory assembly which overcomes the above-mentioned disadvantages of the previously known ladder accessories.

In brief, a multipurpose ladder accessory assembly for a ladder compactly stores at least two pairs of ladder accessories arms on the ladder. The ladder has a top rung, a penultimate rung and a multiple of lower rungs each extending between a first elongated ladder rail and a second elongated rail of the ladder. The first arm of each pair of ladder accessory arms is connected to the first ladder rail between the upper end of the first ladder rail and the penultimate rung, and a second arm of each pair of ladder accessory arms is connected to the second ladder rail between the upper end of the second ladder rail and the penultimate rung.

The first arms and the second arms of the first and the second pair of ladder accessory arms are independently moveable from a folded position along the ladder rails to an extended position from the ladder rails. In the folded position at least one of the first or the second pair of ladder accessory arms are aligned with the longitudinal direction of the first and second ladder rails. The first arms of the first and the second pair of ladder accessory arms overlap when in the folded position and the second arms of the first and the second pair of ladder accessory arms overlap when in the folded position.

In this manner, the first and the second pairs of ladder accessory arms can be stored compactly when not in use, and can be quickly and independently deployed when a ladder accessory requirement arises.

### BRIEF DESCRIPTION OF THE DRAWINGS

FIG. 1 is a front perspective view illustrating the invention in an extended position;

FIG. 2 is a front perspective view illustrating the invention depicted in FIG. 1 with an additional support brace;

FIG. 3 is a front elevational view illustrating the inventive stabilizer depicted in FIG. 2 in a folded position; and

FIG. 4 is a side elevational view illustrating the invention of FIG. 1 with a support brace substituted for the lateral brace.

### DETAILED DESCRIPTION OF THE INVENTION

The present invention has utility as a multipurpose ladder accessory assembly which overcomes the above-mentioned disadvantages. By providing a user with at least two pairs of ladder accessories that are already attached to the ladder, the user will not have to attach an accessory when the requirement arises. Rather, the user of the present invention need only to move a selected accessory from a folded position to an extended position for the selected accessory.

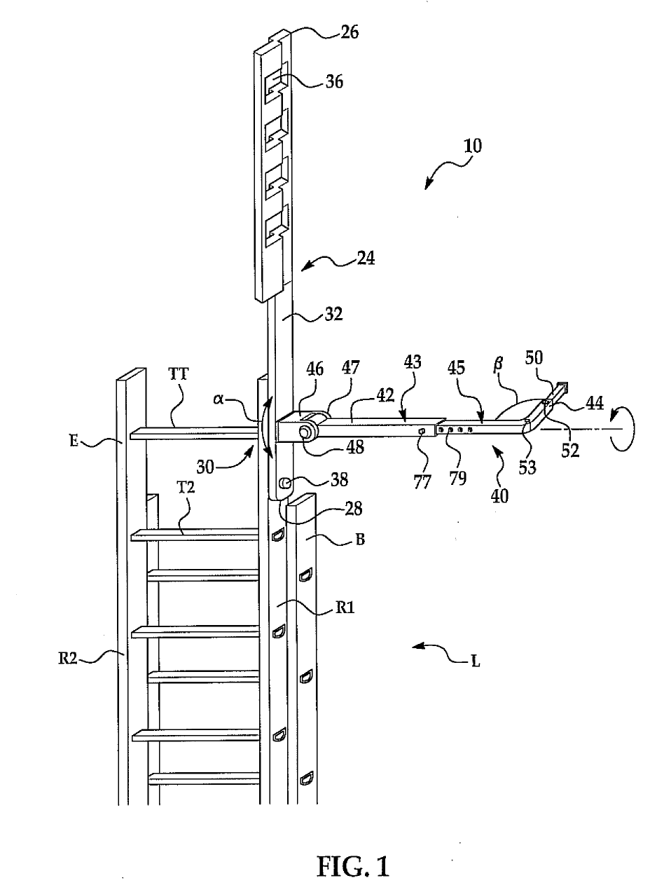

With reference to FIG. 1, an inventive multipurpose ladder accessory assembly is illustrated generally at 10. The accessory assembly 10 is attached to a ladder L which includes a pair of spaced apart parallel ladder rails R1 and R2. Rungs T extends between the ladder rails R1 and R2 and includes a top rung TT. The ladder L can be of the type known as an extension ladder having a top ladder section E which is slidably engageable with a bottom ladder section B so as to extend the overall length of the ladder L.

The accessory assembly 10 includes at least a first pair of ladder accessory arms defining a first arm and a second arm, and a second pair of ladder accessory arms defining a first arm and a second arm. The first and second arms of the first and second pair of ladder accessory arms are secured to the rails R1 and R2, respectively. For visual clarity only the first arm of the first pair of ladder accessory arms and the first arm of the second pair of ladder accessory arms are depicted affixed to rail R1 in the figures. It is to be understood that the discussion of the first arms of the first and second pairs of ladder accessory arms that follows there is an identical, mirror image second arm attached to rail R2 for the first and second pair of ladder accessory arms

The first pair of ladder accessory arms is a pair of handrail arms having a first handrail arm 24 extending from rail R1 and a complementary second handrail arm extending from rail R2 (omitted for visual clarity). Handrail arm 24 has a top end 26 and a bottom end 28. The handrail arm 24 is rotatably attached to a corresponding ladder rail R1 at a connection point 30. The handrail arm 24 is rotatable about the connection point 30. The plane created by the rotation of the handrail arm 24 about the connection point 30 is at an angle α between 0 and 180 degrees to the longitudinal direction of the rails, and in the specific form depicted the plane created by the rotation of the handrail arm 24 is generally rotated 180° to an extended position along R1. The connection point 30 of the handrail arm 24 and the ladder rail R1 is anywhere along the ladder rail R1, preferably between the top end of the ladder rail R1 and the intersection of the ladder rail R1 and the penultimate rung T2. To increase the structural support for the accessory assembly, the connection point 30 is preferably located at the intersection of the ladder rail R1 and the top rung TT or the penultimate rung T2. The connection point 30 is positioned between the top end 26 and the bottom end 28 so as to define a gripping portion 32 between the top end 26 and the connection point 30, and a securing end 34 located between the connection point 30 and the bottom end 28 of the handrail arm 24.

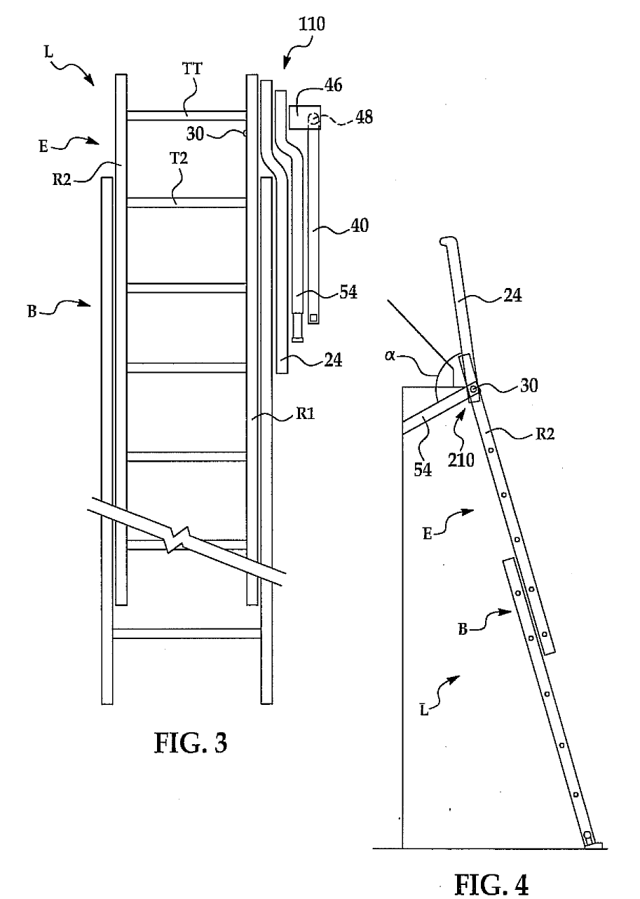

The gripping portion 32 of the handrail arm 24 optionally includes multiple apertures 36 formed therethrough which extend along the longitudinal axis of the handrail arm 24. The securing end 34 of the handrail arm 26 optionally includes a fastener 38 for rigidly securing the handrail arm 24 to the ladder rail R1. The fastener 38 is of any type known to those of ordinary skill in the art to releasably and rigidly secure the handrail arm 24 to the ladder rail R1 such as a hand retractable spring plunger, a bolt with a wing nut, or the like. The ladder rail R1 includes a pair of apertures (not shown) located on either side of the connection point 30. The apertures are configured to receive the fastener 38. The aperture located below the connection point 30 is used to rigidly secure the handrail arm 24 in the extended position as shown in FIG. 1, while the aperture located above the connection point 30 is used to rigidly secure the handrail arm 24 to the ladder rail R1 in the folded position, as seen in FIG. 3.

The second pair of ladder accessory arms is a pair of lateral brace arms having a first lateral brace arm 40 extending from rail R1 and a complementary second lateral brace arm extending from rail R2 (omitted for visual clarity). The lateral brace arm 40 has a connection end 42 and a supporting end 44. A portion of the lateral brace arm 40 adjacent the support end 44 is curved such that the support end 44 extends at an angle β of between 30 and 120 degrees and in the specific form depicted is generally normal to the longitudinal direction of the lateral brace 40. The lateral brace arm 40 optionally includes a releasable, locking pivot 53 which allows the portion of the lateral brace arm 40 adjacent the supporting end 44 to pivot relative to the portion of the lateral brace arm 40 adjacent the connection end, such that the angle α is variable by a user. The user can secure the portion of the lateral brace arm 40 adjacent the supporting end 44 in a fixed position along its rotation to secure the selected angle α. This allows the user to specifically customize the lateral brace arm 40 in order to meet a ladder accessory requirement.

The lateral brace arm 40 is pivotally connected to an outwardly extending tab 46 by a hinge 48 at the connection end 42 of the lateral brace arm 40. Optimally the lateral brace arm 40 is formed of a first tubular section 43 that telescopically joins to a second tubular section 45. A locking pin 77 selectively mates to one of a set of holes 79 spaced along the second tubular section 45. The outwardly extending tab 46 is rigidly affixed to the ladder rail R1 such that the lateral brace arm 40 is movable only about the hinge 48. The plane created by the rotation of the lateral brace arm 40 about the hinge 48 is at an angle between 60 and 120 degrees to the plane created by the rotation of the handrail arm 24 and in the specific form depicted the plane created by the rotation of the lateral brace arm 40 is generally normal to the plane created by the rotation of the handrail aim 24. The outwardly extending tab 46 further includes a hinge fastener 47 to lock the lateral brace 46 in a fixed position along its rotation. The hinge fastener 47 may be any means known to those of ordinary skill in the art such as a slide bolt or the like.

Alternatively, outwardly extending tab 46 is rotatably attached to ladder rail R1 at connection point 30 such that the plane created by the rotation of the outwardly extending tab 46 is parallel the plane created by the rotation of the handrail arm 24. The outwardly extending tab 46 is fastened to secure the tab 46 at any point along its rotation. Thus, in addition to using lateral brace arm 40 as a lateral brace it could also be used as a hook to further stabilize the ladder L.

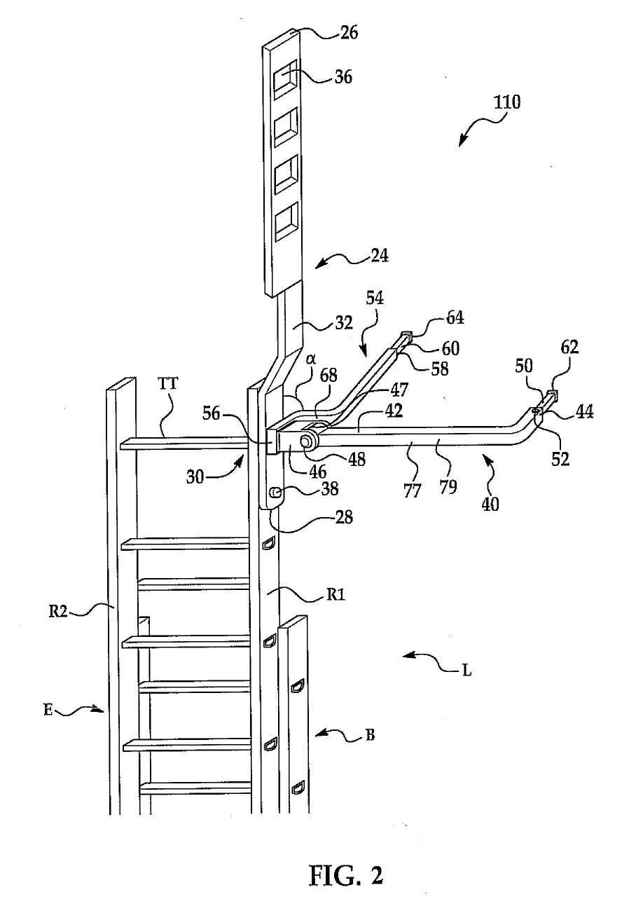

With reference to FIG. 2 the accessory assembly 110 optionally includes a third pair of ladder accessory arms. The third pair of ladder accessory arms are a first support brace arm 54 attached to rail R1 and a complementary second support brace arm extending from rail R2 (omitted for visual clarity). The support brace arm 54 has a connection end 56 and a support end 58. The connection end 56 of the support brace arm 54 is rotatably attached to the ladder rail R1 between the handrail arm 24 and the outwardly extending tab 46. The plane created by the rotation of the support brace arm 54 is at an angle γ between 60 and 120 degrees to the plane created by the rotation of the handrail arm 24 and in the specific form depicted the plane created by the rotation of the support brace aim 54 is generally normal to the plane created by the rotation of the handrail arm 24.

It will be appreciated from FIG. 2 that both the lateral brace arm 40 and the support brace arm 54 optionally include projecting portions 50 and 60, respectively, that are slidably engageable with the support ends 44 and 58 of the lateral brace arm 40 and the support brace arm 54. The arms 40 and 54 are constructed of a hollow material having a generally circular, square or any other suitable noncircular cross-sectional shape. The elongated projecting portions 50 and 60 each independently have a cross section that is slightly smaller than that of the proximal arms 40 and 54, respectively, and are slidably engageable with the open support ends 44 and 58, respectively. The arms 40 and 54 preferably are fastened with a fastener 52 in FIG. 2, located adjacent the support ends 44 and 58 for securing the projecting portions 50 and 60, respectively, to the arms 40 and 54, respectively, at different positions along the longitudinal direction of the elongated projecting portions 50 and 60, respectively. As such, the distance between the connection point 30 and the distal end of the projection portions 50 and 60 connected to the arms 40 and 54, respectively, can be increased. Further, the handrail arm 24 could also contain a projecting portion as described above so as to extend the overall length of the handrail arm 24.

As seen in FIG. 2, the accessory assembly 110 is deployed in its extended form. The handrail arm 24 in the extended form extends along the longitudinal direction of the ladder rail R1 so as to extend the overall length of the ladder L. The handrail arm 24 is used by the user while getting on or off an elevated surface such as a roof. The handrail arm 24 allows the user to continue to have a grip on the ladder L as the user climbs the upper rungs of the ladder L to exit the ladder L. Also, when the user is stepping onto the ladder L from an elevated surface the handrail arm 24 stabilizes the user during rung descent.

The support brace arm 54 is used to space the ladder L apart from a vertical supporting surface such that the upper end of the ladder L is stabilized. The support brace arm 54 also allows the user access to a work area on the vertical supporting surface that is between the ladder L and the vertical supporting surface. As such, the user does not have to position the ladder L adjacent the desired work surface and lean or reach outwardly from the ladder L to perform the desired work.

The lateral brace arm 40 is used to stabilize the upper end of the ladder L by providing a point of contact on the vertical surface which is wider than the ladder rails R1 and R2 would otherwise provide. In addition, the lateral brace arm 40 allows the ladder L to be supported even though the upper end of the ladder L would have to rest on an impractical or undesirable portion of the vertical supporting surface such as a window or a rain gutter.

FIG. 3 illustrates the ladder accessory assembly 110 while in the folded position. The handrail arm 24 and the support brace arm 54 both rotate around the connection point 30 such that they are adjacent the ladder rail R1 and overlap each other. The lateral brace aim 40 rotates so as to overlap the handrail arm 24 and the support brace arm 54. The handrail arm 24 and the support brace arm 54 are optionally offset outwardly at offset portions 66 and 68 such that when in the folded position the handrail arm 24 and the support brace arm 54 overlap the bottom ladder section B as seen in FIG. 3. Further, it would be appreciated that FIG. 1 shows that the handrail arm 24 can be configured such that a portion of the gripping portion 24 will be offset so as to overlap the bottom ladder section B even though the handrail arm 24 does not have an offset portion.

It will be appreciated from FIG. 4 that the ladder accessory assembly 210 includes a handrail arm 24 and a support brace arm 54. Further, the disclosed ladder accessory assembly is not limited to the accessories described herein. The ladder accessory assembly can be comprised of any suitable ladder accessory known to those of ordinary skill in the art. The ladder accessory assembly is constructed of any conventional material, such as metal, wood, plastics, fiberglass or the like. In addition, the ladder accessory assembly may be releasably attached to the ladder rails, attached as an aftermarket accessory to the ladder or be formed integral with the ladder during the ladder's fabrication.

In order to facilitate an understanding of the principles associated with the disclosed apparatus, its operation will now be briefly described. The ladder accessory assembly is secured to a ladder as described above. It is desirable that during storage or transportation the accessory arms of the ladder accessory assembly are placed in the folded position wherein each of the arms are parallel with a corresponding ladder rail and that the arms disposed on one ladder rail overlap each other. A user who is confronted with a requirement for a ladder accessory will select the appropriate accessory and move it from the folded position to the extended position. The user may independently deploy a single pair of ladder accessories, all of the ladder accessories or a single ladder accessory arm as the situation requires. The user may then position the lower end of the ladder in a desired position and safely ascend the ladder to complete the desired task. Upon completion of the task the user may ready the ladder for storage or transportation by laying the ladder horizontally on the ground surface and moving the deployed ladder accessories from their extended position to their folded position.

From the foregoing, it can be seen that the present invention provides a multipurpose ladder accessory assembly from which a user can independently deploy accessory arms from their folded position to their extended position. Having described my invention, however, many modifications thereto will become apparent to those skilled in the art to which it pertains without deviation from the spirit of the invention as defined by the scope of the appended claims.

It is claimed:

1. A multipurpose ladder accessory assembly for a ladder having a top rung, a penultimate rung and a plurality of lower rungs each extending between a first elongated ladder rail and a second elongated ladder rail defining ladder rails, each ladder rail having an upper end and a lower end, said accessory assembly comprising:
a first pair of ladder accessory arms defining a first arm connected to the first ladder rail between the upper end of the first ladder rail and the penultimate rung, and a second arm connected to the second ladder rail between the upper end of the second ladder rail and the penultimate rung, such that each of said first arm and second arm of said first pair of ladder accessory arms are independently moveable from a folded position along the ladder rails to an extended position from the ladder rails;
a second pair of ladder accessory arms defining a first arm connected to the first ladder rail between the upper end of the first ladder rail and the penultimate rung, and a second arm connected to the second ladder rail between the upper end of the second ladder rail and the penultimate rung, such that each of said first arm and second arm of said second pair of ladder accessory arms are independently moveable from a folded position along the ladder rails to an extended position from the ladder rails.

2. The ladder accessory assembly of claim 1, wherein the longitudinal axis of at least one of said first pair of ladder accessory alms or said second pair of ladder accessory arms are aligned with the longitudinal direction of the first and second ladder rails when in the folded position; and
wherein said at least one of said first pair of ladder accessory arms or said second pair of ladder accessory arms extend in different directions in the extended position to stabilize the ladder.

3. The ladder accessory assembly of claim 1, wherein said first arm of said first pair of ladder accessory arms and said first arm of said second pair of ladder accessory arms overlap when in the folded position; and
said second arm of said first pair of ladder accessory arms and said second arm of said second pair of ladder accessory arms overlap when in the folded position.

4. The ladder accessory assembly of claim 1, wherein said first pair of ladder accessory arms is a pair of handrail arms having a first handrail arm with a first handrail arm proximal end rotatably attached to the first ladder rail and a first handrail arm distal end being opposite said first handrail arm proximal end, and a second handrail arm with a second handrail arm proximal end rotatably attached to the second ladder rail and a second handrail arm distal end being opposite said second handrail arm proximal end; and
wherein the longitudinal direction of said first handrail arm and second handrail arm are aligned with the longitudinal direction of the first ladder rail and the second ladder rail in the extended position, such that said first handrail distal end and said second handrail distal end are disposed farther from the lower end of the first ladder rail and the second ladder rail when in the extended position than when in the folded position.

5. The ladder accessory assembly of claim 4, wherein said first handrail arm and second handrail arm each include a projecting portion that is slidably engageable with said first handrail arm distal end and said second handrail arm distal end such that the overall length of each of said first handrail arm and said second handrail arm are extendable.

6. The ladder accessory assembly of claim 1, wherein said second pair of ladder accessory arms is a pair of support brace arms having a first support brace arm with a first brace proximal end rotatably attached to the first ladder rail and a first brace distal end being opposite said first brace proximal end, and a second support brace arm with a second brace proximal end rotatably attached to the second ladder rail and a second brace distal end being opposite said second brace proximal end; and
wherein said first brace distal end and said second brace distal end abut a vertical supporting surface such that the ladder is spaced apart from said vertical supporting surface when in the extended position.

7. The ladder accessory assembly of claim 6, wherein at least one said first support brace arm and said second support brace arm further comprises a projecting portion that is slidably engageable with at least one of said first brace distal end or said second brace distal end.

8. The ladder accessory assembly of claim 1, further comprising a third pair of ladder accessory arms, said third pair of ladder accessory arms being a pair of lateral brace arms having a first lateral brace arm with a first lateral brace proximal end hingeably attached to the first ladder rail between the upper end of the first ladder rail and the penultimate rung and a first lateral brace distal end being opposite said first lateral brace proximal end, and a second lateral brace arm having a second lateral brace proximal end hingeably attached to the second ladder rail between the upper end of the second ladder rail and the penultimate rung and a second lateral brace distal end being opposite said second lateral brace proximal end; and
wherein the planes created by the rotation of said pair of lateral brace arms is generally normal to the planes created by the rotation of at least one of said pair of ladder accessory arms or said second pair of ladder accessory arms.

9. The ladder accessory assembly of claim 8, wherein said first lateral brace arm and said second lateral brace arm are curved such that the first lateral brace distal end of said first lateral brace arm and the second lateral brace distal end of said second lateral brace arm extend in a direction generally normal to said the first lateral brace proximal end of said first lateral brace arm and the second lateral brace proximal end of said second lateral brace arm, such that the ladder is spaced apart from said vertical supporting surface when in the extended position.

10. The ladder accessory assembly of claim 8, wherein at least one of said first lateral brace arm and second lateral brace arm further comprise a projecting portion that is slidably engageable with at least one of said first lateral brace distal end or said second lateral brace distal end.

11. The ladder accessory assembly of claim 1, wherein at least one of said first pair of ladder accessory arms or second pair of ladder accessory arms includes an outwardly offset portion.
